(19) United States
(12) Patent Application Publication
(10) Pub. No.: US 2008/0208631 A1
(43) Pub. Date: Aug. 28, 2008

(54) METHODS AND SYSTEMS FOR PROVIDING CLINICAL DOCUMENTATION FOR A PATIENT LIFETIME IN A SINGLE INTERFACE

(75) Inventors: Mark Morita, Arlington Heights, IL (US); Donald Woodlock, Deer Park, IL (US); Andrew Isaac Deitsch, Lake In The Hills, IL (US); Brandon Richard Savage, Woodinville, WA (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/757,001

(22) Filed: Jun. 1, 2007

Related U.S. Application Data
(60) Provisional application No. 60/891,174, filed on Feb. 22, 2007.

(51) Int. Cl. G06Q 50/00

(52) U.S. Cl. 705/3

(57) ABSTRACT

Certain embodiments of the present invention provide methods and systems for comprehensive clinical documentation of patient lifetime via a unified interface. Certain embodiments provide a user interface system displaying an electronic patient record. The system includes a timeline representation of a patient record. The timeline includes a plurality of data points related to a patient over time. The plurality of data points provides patient data aggregated from a plurality of information sources. The timeline provides access to and review of the plurality of data points within a single view. The system includes one or more controls allowing navigation and manipulation of one or more of the plurality of data points in the timeline.

### BACKGROUND OF THE INVENTION

The present invention generally relates to aggregating and viewing patient data. More particularly, the present invention relates to methods and systems providing documentation for a patient lifetime via unified interface.

A clinical or healthcare environment is a crowded, demanding environment that would benefit from organization and improved ease of use of imaging systems, data storage systems, and other equipment used in the healthcare environment. A healthcare environment, such as a hospital or clinic, encompasses a large array of professionals, patients, equipment and computerized information systems. Personnel in a healthcare facility must manage a plurality of patients, systems, and tasks to provide quality service to patients. Healthcare personnel may encounter many difficulties or obstacles in their workflow.

Healthcare has become centered around electronic data and records management. Healthcare environments, such as hospitals or clinics, include information systems, such as healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information for a particular information system may be centrally stored or divided at a plurality of locations. Healthcare practitioners may desire to access patient information or other information at various points in a healthcare workflow. For example, during an imaging scan of a patient, medical personnel may access patient information, such as a patient exam order, that are stored in a medical information system. Alternatively, medical personnel may enter new information, such as history, diagnostic, and/or treatment information, into a medical information system during an imaging scan.

Different clinical departments and different clinical systems gather patient information in different ways and in different forms and often separately store that information. The information must then be retrieved and viewed from several disparate systems.

Current information and management systems do not offer interconnection and flexibility. Current clinical information systems are typically modified manually by programmers for particular users. Many components of a patient care or practice management workflow are paper-based or not present at all. Current systems do not provide a central system by which a user may access and interrelate patient information, resource information, orders, and results. Many third party vendors providing a variety of solutions also present difficulties regarding interoperability and connectivity.

Currently, relevant patient information for a patient's entire lifetime exists in a number of formats that include paper, folders and disparate information systems from a variety of vendors and a variety of healthcare providers. Current systems cannot aggregate this information effectively. Additionally, current systems cannot display this information at one time so that healthcare providers have the ability to interpret a patient's complete medical history when assessing and diagnosing illnesses. Providers are rarely able to see the full history of a patient. More commonly, providers have only the information that they have gathered or that they have received in response to questions asked of the patient in a clinical setting. Key decisions are made with the limited knowledge available to the provider at the point at which the provider is making a decision.

Thus, systems and methods providing aggregated clinical information would be highly desirable. Systems and methods aggregating information over time would be highly desirable. Systems and methods providing a chronology of patient care would also be highly desirable.

While the LifeLines prototype at the University of Maryland represents an electronic medical record as a series of timelines, the LifeLines system lists high-level information for pattern visualization. To drill down to granular information, such as liver panel or white blood count, a user of the LifeLines application must click on a graphical icon that opens a preview panel to a separate file or structure containing this information. The granular information is not embedded into the interface but is rather stored and displayed separately. Opening a preview window also causes the timeline to compress, so the viewer loses some of the high level context of the initial navigation when reviewing granular information. Loss of high level content may create confusion and frustration for users.

Thus, a need exists for systems and methods that allow users to view an entire patient context in a single interface. There is a need for systems and methods that allow users to view a timeline of patient data in a unified interface. There is a need for systems and methods allowing a user to dynamically alter patient and practice management functionality and data. Additionally, a need exists for systems and methods with configuration capability allowing a user to interactively relate patient and practice management functionality and data. Such systems and methods may provide for comprehensive patient and/or practice management on a single computer screen or other portal. In addition, such systems and methods may provide for the customization of the manner in which information is entered, viewed, and/or used by a user. Furthermore, systems and methods facilitating interactions with third party applications and protecting patient privacy would be highly desirable.

### BRIEF SUMMARY OF THE INVENTION

Certain embodiments of the present invention provide methods and systems for comprehensive clinical documentation of patient lifetime via a unified interface.

Certain embodiments provide a user interface system displaying an electronic patient record. The system includes a timeline representation of a patient record. The timeline includes a plurality of data points related to a patient over time. The plurality of data points provides patient data aggregated from a plurality of information sources. The timeline provides access to and review of the plurality of data points within a single view. The system includes one or more controls allowing navigation and manipulation of one or more of the plurality of data points in the timeline.

Certain embodiments provide a comprehensive patient record including electronic patient data for a patient lifetime. The electronic patient data is arranged in chronological order and viewable in a single context at varying degrees of granularity within the single context. The electronic patient data is aggregated from a plurality of data sources for viewing and modification via the single context.

Certain embodiments provide a method for providing comprehensive clinical documentation for a patient lifetime via a single, unified interface. The method includes providing a comprehensive patient record. The record includes a plurality of data points related to a patient over time. The plurality of data points provides patient data aggregated from a plurality of information sources. The record provides access to and review of the plurality of data points within a single patient context. The method includes manipulating the record based on input from an interface to access finer granularity information from the record.

Certain embodiments provide a computer readable medium having a set of instructions for execution on a computer. The set of instructions includes a user interface routine displaying an electronic patient record. The electronic patient record includes a plurality of data points related to a patient over time. The plurality of data points provides patient data aggregated from a plurality of information sources. The interface routine provides access to and review of the plurality of data points within a single view. The set of instructions also includes a control routine facilitating navigation and manipulation of the electronic patient record to at least one of view and modify one or more of the plurality of data points in the record.

### BRIEF DESCRIPTION OF SEVERAL VIEWS OF THE DRAWINGS

FIG. 1 depicts a visualization of an exemplary patient's complete medical record in accordance with an embodiment of the present invention.

FIG. 2 shows an exemplary magnification of all or part of a patient record timeline to provide additional information regarding patient data points in accordance with an embodiment of the present invention.

FIG. 3 depicts a further magnification of a particular event to view greater detail regarding the event and surrounding data in accordance with an embodiment of the present invention.

FIG. 4 illustrates a further magnification of a patient record according to an embodiment of the present invention.

FIG. 5 illustrates further magnification of a patient record timeline allowing a user to review and edit one or more data points in the record in accordance with an embodiment of the present invention.

FIG. 6 illustrates a flow diagram for a method for documentation of a patient lifetime in a patient record according to an embodiment of the present invention.

FIG. 7 illustrates a system for clinical data storage and retrieval in accordance with an embodiment of the present invention.

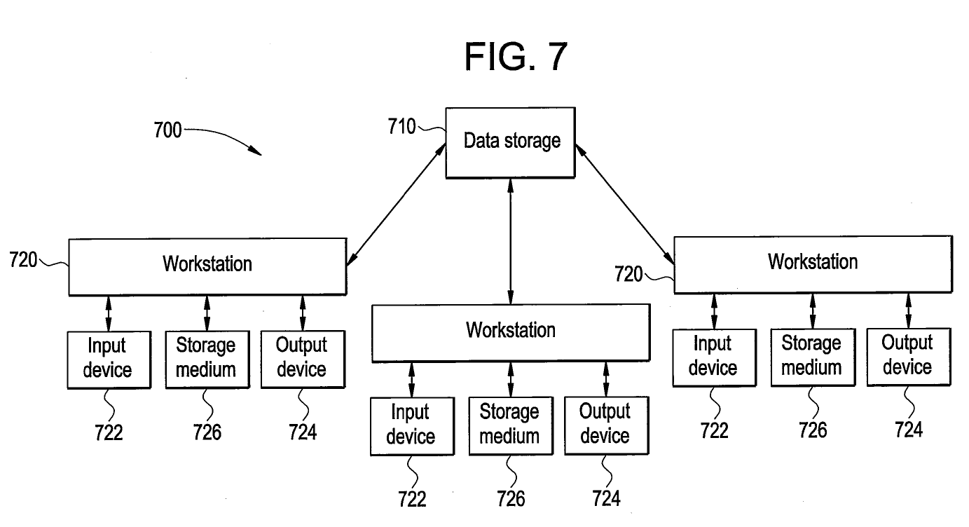

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide methods and systems providing comprehensive clinical documentation for a patient's entire lifetime in one easy-to-use interface. Certain embodiments enable a patient's entire medical history to be displayed, edited and interacted within one context. Users may view an entire gestalt of a patient history or timeline at a high level to better understand an overall health of a patient. From a high level overall vantage point, the user may navigate to any specific item on the patient's history by using a navigational cursor, mouse click, touch screen, voice command, gaze tracking, etc. The user can drill down to isolated metadata in the timeline to view specific lab reports, physical exam notes, procedures, etc. Thus, a user can navigate a complete set of patient healthcare data via a unified interface by scrolling, dragging, expanding, shrinking, etc., via the interface.

A patient EMR and/or other record include a medical history for a patient and include data with time stamps (or times and dates at which data was collected or entered). Types of data may include test names, test results, imaging procedures, medical visits (e.g., hospital, office, clinic, etc.), medical problem, caregiver encounter, medical procedure, symptoms, biological analysis, finding, medication, acquisition, etc. These types/categories of data can each be represented by a symbol on a common and/or individual timeline for each event of the data occurrence, for example.

In certain embodiments, EMRs can present data in visual manner by presenting a timeline with symbols representing each patient encounter. A patient encounter can include any test, visit, or other encounter with any physician, nurse, radiologist, image technician or other caregiver, for example. With many patient encounters, the timeline can get too cluttered and difficult to visualize associations between data. Data can be associated in a number of ways, such as by patient encounter (e.g., office/hospital visit/stay), time/date range, problem (e.g., diabetes, heart disease, broken bone, etc.), procedure (e.g., surgery, series of lab tests, etc.), collecting/entering hospital/clinic/caregiver, etc.

In certain embodiments, the user interface differs from data mapping applications at least in that data is not simply provided as bitmapped photographs but instead and/or in addition includes editable data points that have an ability to hyperlink or otherwise connect to and/or view finer granularity information. In certain embodiments, information may all be contained in a single patient history and may become visible as areas of the timeline are further magnified and accessed, for example. Healthcare professionals can also add information to the patient context by inputting textual data or multimedia data, via voice commands and/or by synchronization to available third party healthcare information systems, for example.

In certain embodiments, a rendering engine may “chart” or map aggregated data into a single timeline interface. As new data is collected, the rendering engine can “redraw” the timeline and update the interface.

In certain embodiments, a patient would not only own his or her own data, but would have an ability to share data with any healthcare provider, payer, clinical trial, etc. For example, a patient's data may be routed to another application, database, information system, portable medical record, etc.

In certain embodiments, comprehensive patient data points may be aggregated into a single location (e.g., a thumbdrive, CD, DVD, hard drive, etc.). Export capability from a plurality of clinical applications allows aggregation and storage of information to a single locale.

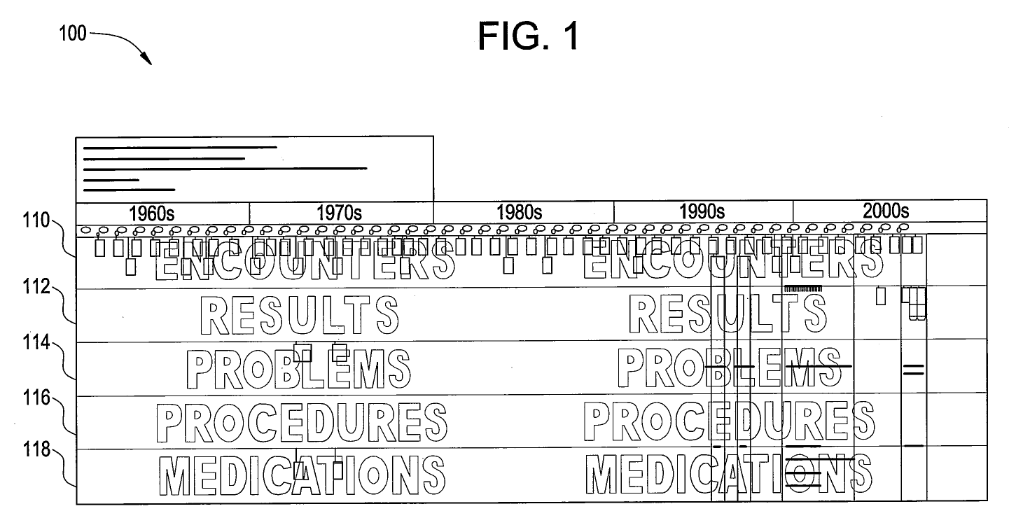

FIG. 1 depicts a complete visualization of an exemplary 44 year old male's complete medical record in accordance with an embodiment of the present invention. At a high level, a user can see each clinical encounter, lab result, report, etc., that exists for the patient. From the high level view, an overall health of a patient can be assessed with specific visual queues that indicate specific problems or events that have occurred for the patient, for example. Rather than interviewing a patient to rely on memory for the granularity of information, a provider has the entire patient context available for assessment via a timeline-based interface. Information can be segmented in a variety of categorizations, for example. For purposes of illustration only, FIG. 1 segments information into Encounters, Results, Problems, Procedures and Medications.

As discussed above, FIG. 1 shows a high level view of a patient timeline displayed graphically for a user. All information for the patient is contained in one context. Patient data is organized by time and correlated with other patient data. A user can view and edit data within the timeline interface.

A user may navigate, manipulate and view different information and different levels/granularity of information in the interface by dragging, scrolling and/or otherwise moving a viewpoint via mouse and cursor, keyboard, trackball, touch screen, etc. The patient timeline may be displayed on a computer monitor, an overhead display, a grease board, a viewing table, etc. In certain embodiments, a viewing table or display projects or otherwise displays the patient history on the table for viewing by a user. In certain embodiments, the viewing surface is touch sensitive and/or associated with motion tracking capability to allow a user to navigate, view and/or modify information in the patient history. In certain embodiments, user(s) actions are detected and tracked by one or more sensors position with respect to the user and with respect to the viewing surface, for example. In certain embodiments, one or more users may view and/or modify information in the timeline simultaneously or substantially simultaneously.

At higher magnification, greater details of the patient start becoming clearer. Based on particular events or problems, the user may choose to zoom in further for greater detail. Further magnification allows greater detail for a particular patient event or source of information. Information displayed may have hyperlinks attached to allow the user to navigate to an information system that initially generated the data to drill down on finer details. Alternatively and/or in addition, finer details related to the information may be present in the patient history context and become viewable and reviewable as the user drills down into the timeline.

In certain embodiments, at higher levels of magnification, additional text becomes more legible and allows a user to view finer detail regarding a particular problem, intervention, report, etc. At even higher magnifications, a user may review and edit data points. Users may annotate relationships of metadata as the metadata pertain to a particular patient being displayed. For example, a user may draw lines to connect problems or circles to group a number of data points to allow a user to visualize relationships and create links to help guide a decision making process.

Users may also review and/or edit specific lab results, childhood immunizations, specific treatment plans, etc. Certain areas of a patient record can be tagged or bookmarked to allow a user to easily drill down to a specific problem or event upon future access, for example.

Thus, certain embodiments allow healthcare providers to see a patient's entire medical record at a single glance. Users are provided with an ability to interactively review information that is relevant to a patient and ignore events or problems that may not be relevant to a current situation. In certain embodiments, hyperlinks allow users to launch and/or access information systems that have more detailed and/or additional documentation that may include radiology images, waveforms, etc. In certain embodiments, addition information from disparate information systems is aggregated into the record for access within the record based on further magnification and “drilling down” into finer levels of granularity within the displayed record. Certain embodiments provide a single repository for patient data that helps provide patients an ability to own, transport and share their own data. Certain embodiments aggregate a patient's lifetime healthcare record in a single context and provide an ability to review the entire dataset at a single glance (e.g., from a single display or interface). In certain embodiments, a lifetime patient healthcare record may be stored on a smart card, thumbdrive, CD, DVD, hard drive, portable memory and/or other medium, for example. Data may be aggregated and stored for later use, for example.

As illustrated, for example, in FIG. 1, a complete patient timeline 100 may be viewed from a high level. The timeline 100 may be divided into a plurality of categories, such as encounters 110, results 112, problems 114, procedures 116 and medication 118. Using the timeline 100, a high level visualization of encounters/visits and results/data may be viewed for a patient lifetime.

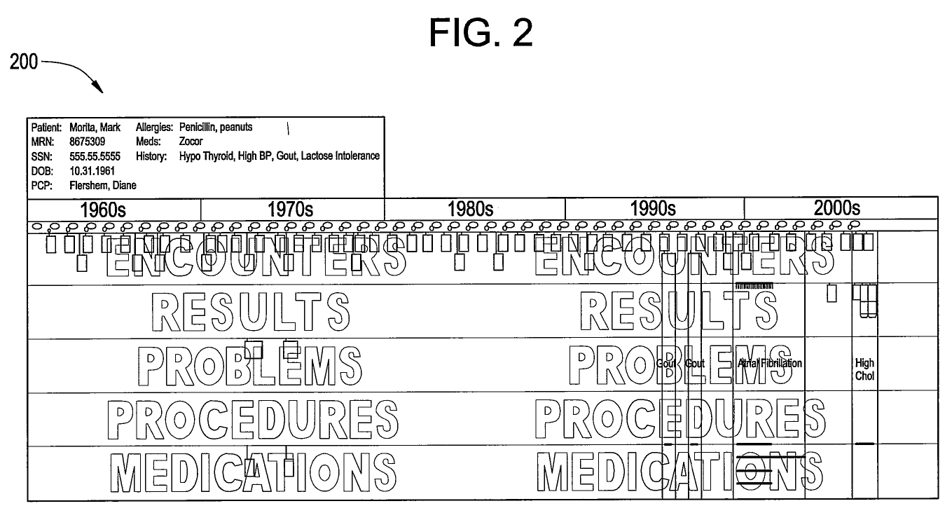

As shown in FIG. 2, for example, a magnification of all or part of a patient record timeline 200 provides additional information regarding patient data points, such as events, problems, reports, etc. For example, in the interface 200 of FIG. 2, patient data 220, such as gout, atrial fibrillation, high cholesterol, etc., become legible and/or otherwise visible on the patient record at a point or point(s) in time at which the event or condition occurred, for example.

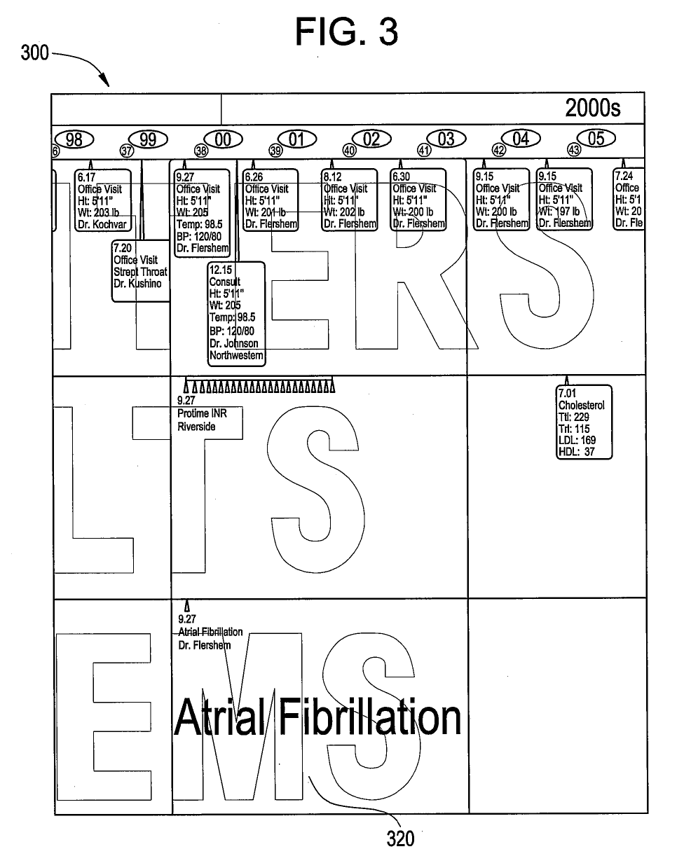

As depicted in FIG. 3, a user may further magnify a particular event to view greater detail regarding an event 320 and surrounding data. A user may select and/or further magnify information displayed to access additional detail and/or connect to an information system including additional detail regarding the selected data point, for example.

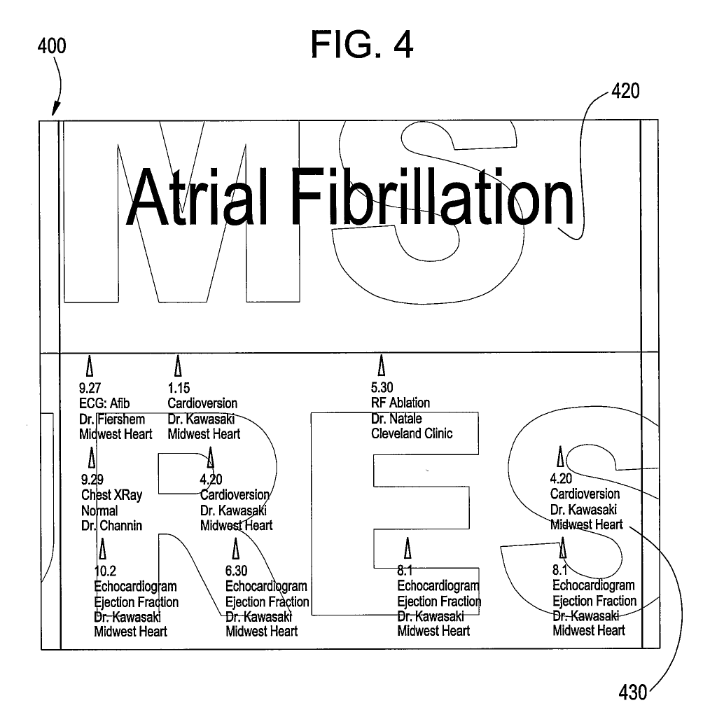

FIG. 4 illustrates a further magnification of a patient record 400 according to an embodiment of the present invention. Further magnification allows a user to view finer detail in conjunction with a problem or intervention. For example, a user may view test(s), procedure(s), and/or examination(s) 430 saved with respect to a particular patient problem 420, such as atrial fibrillation.

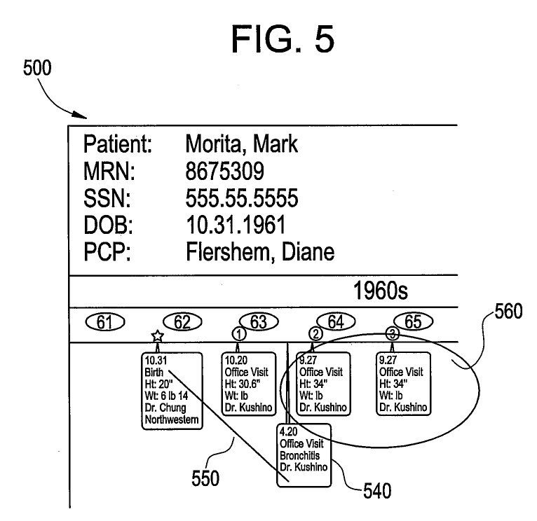

In FIG. 5, further magnification of a patient record timeline 500 allows a user to review and edit one or more data points 540 in the record 500. For example, a user may annotate the record 500 with one or more lines 550 and/or other indicia to connect problems, issues, important formation related information, and/or other data points. A user may also circle 560 one or more data points to create a relationship between those data points. Further annotations may allow a user to highlight, tag and/or otherwise add information to the record 500 and/or one or more component data points to aid in patient diagnosis, treatment and/or study, for example.

In certain embodiments, a patient medical record aggregated information from a plurality of information systems under a common patient context. Information systems may include a radiology information system (RIS), a picture archiving and communication system (PACS), Computer Physician Order Entry (CPOE), an electronic medical record (EMR), Clinical Information System (CIS), Cardiovascular Information System (CVIS), Library Information System (LIS), and/or other healthcare information system (HIS), for example. An interface facilitating access to the patient record may include a context manager, such as a clinical context object workgroup (CCOW) context manager and/or other rules-based context manager. Components may communicate via wired and/or wireless connections on one or more processing units, such as computers, medical systems, storage devices, custom processors, and/or other processing units. Components may be implemented separately and/or integrated in various forms in hardware, software and/or firmware, for example.

Certain embodiments may be used to provide an integrated solution for application execution and/or information retrieval based on rules and context sharing, for example. For example, context sharing allows information and/or configuration options/settings, for example, to be shared between system environments. Rules, for example, may be defined dynamically and/or loaded from a library to filter and/or process information generated from an information system and/or an application.

Information for a particular patient may be extracted and/or linked from one or more information systems for presentation to a user via a unified patient record timeline, for example. In certain embodiments, information retrieval, display and/or processing settings, for example, may be customized according to a particular user or type of user. Retrieval, aggregation, display and/or processing of information may be based on rules, preferences, and/or other settings, for example. Rules, preferences, settings, etc. may be generated automatically based on preset parameters and/or observed data, for example. Rules, preferences, settings, etc., may be created by a system administrator or other user, for example. Rules, preferences, settings, etc., also may be manually and/or automatically adapted based on experiences, for example.

In certain embodiments, a user may log on any one of the connected systems and/or a separate system to access information found on all of the connected systems through context sharing and a unified user interface. In certain embodiments, information may be filtered for easier, more effective viewing.

In certain embodiments, a user interface providing a patient record may work together with a perspectives management system for handling multiple applications and workflow, for example. The perspectives management system allows various perspectives to be defined which save workflow steps and other information for a particular user. Perspectives may be used to save visual component positioning information and interactions based on workflow, for example. Perspectives allow relevant information to be presented to a user.

In certain embodiments, a patient record provides identification information, allergy and/or ailment information, history information, orders, medications, progress notes, flowsheets, labs, images, monitors, summary, administrative information, and/or other information, for example. The patient record may include a list of tasks for a healthcare practitioner and/or the patient, for example. The patient record may also identify a care provider and/or a location of the patient, for example.

In certain embodiments, an indication may be given of, for example, normal results, abnormal results, and/or critical results. For example, the indication may be graphical, such as an icon. The user may select the indicator to obtain more information. For example, the user may click on an icon to see details as to why a result was abnormal. The user may be able to view only certain types of results. For example, the user may view only critical results.

Filters and/or rules may be provided for views and/or categories. Ranges, such as values or dates, may be specified for data. Default views, categories, filters, rules, and/or ranges may be provided. In certain embodiments, default values may be modified by a user and/or based on operating conditions. In certain embodiments, new views, categories, filters, rules, ranges, etc., may be created by a user.

For example, a filter may be used to filter medical results data presented to a user according to one or more variables. For example, when a filter is selected by a user, a modification routine applies the filter to the results displayed to the user in the current view by removing from display all medical results that do not fall within the filter. As described above, a variable may be any data or information included in medical data. For example, a variable may include one or more of a type (or item) and/or range of laboratory test results, vital sign measurements, fluids administered to a patient, and/or fluids measured from a patient. A variable may include text from notes, laboratory reports, examination reports, one or more captions to a laboratory test result, vital sign measurement, and/or fluids administered to/measured from a patient, an order for a laboratory test, treatment and/or prescription, and/or a name. By specifying one or more limits on one or more variables, a user may create a filter to be applied to results presented in a results window.

In certain embodiments, a unified user interface is in communication with one or more applications and/or information systems, for example. The unified user interface interacts with individual interfaces for the application(s) and/or system(s) and masks or hides the individual interfaces from a user. That is, the user sees and interacts with the unified user interface rather than the underlying individual interfaces. A user may be authenticated at the unified user interface. Authentication at the unified user interface may propagate through the connected application(s) and/or system(s), for example.

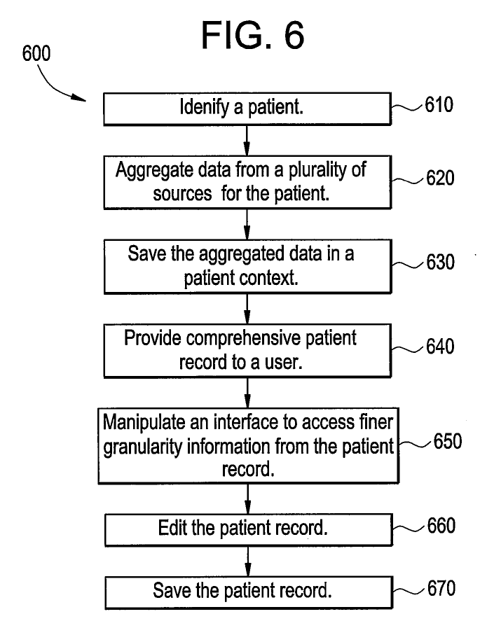

FIG. 6 illustrates a flow diagram for a method 600 for documentation of a patient lifetime in a patient record according to an embodiment of the present invention. At step 610, a particular patient is identified. For example, patient Mark Morita is identified for creation of a comprehensive electronic patient record. At step 620, data is aggregated from a plurality of sources for the patient. For example, data for the identified or otherwise selected patient is retrieved from one or more sources, such as a PACS, RIS, EMR, HIS, etc., and aggregated or combined into a timeline or comprehensive view of patient data over the life of the patient.

At step 630, aggregated data is saved in a patient context. For example, a lifetime EMR for a patient may include the aggregated data. Alternatively, links to the component data may be saved with respect to an interface for later retrieval/use by a user or automated system, for example.

At step 640, the comprehensive patient record is provided to a user. For example, a user may view the comprehensive patient record and constituent data via a user interface such as a display, a touch screen, a viewing table with sensors, etc. At step 650, a user may manipulate the interface to access finer granularity information from the patient record. For example, a user may drill down or otherwise navigate with respect to an area of the timeline and/or particular data point to view additional detail for the area, time, data point, etc., in the patient record.

At step 660, a user may edit the patient record. For example, a user may annotate (e.g., connect and/or group by linking with a line, circling, etc.) data points in the record. As another example, a user may open and edit one or more data points included in the patient record using one or more input sources such as a keyboard, touch screen, stylus, voice command, eye tracking, etc. A user may add and/or delete one or more data points in the record, for example. A user may tag or bookmark one or more data points for easier notice/access in later use, for example. At step 670, a user may save the patient record. The patient record may be saved to an information system, EMR, portable medium, smart card, barcode, etc. Thus, modifications/annotations to the record may be saved for later retrieval and/or other use.

One or more of the steps of the method 600 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

In certain embodiments, changes or evolution in one or more data points in a patient's timeline record may be displayed through a change tracking function. In certain embodiments, a user is provided with an ability to turn on or disable the change tracking function. For example, the user may select a view that displays a medical document and/or other data in only its present form, with previously deleted material hidden. Alternatively, the user may select a view that represents how the medical document appeared on a particular date in its history, perhaps when some of the material presently deleted was still in the document, and without displaying matter added after the particularly selected date. Another embodiment shows a timeline or progression of diagnosis, treatment, and/or other medical data as it has changed over a certain period of time (e.g. over a patient's lifetime, the previous five years, since the birth of a child, etc.). The user may also be provided with an ability to toggle certain other features of the application, such as the ability to hide or show comments.

For example, material and data from previous versions of a medical document appear in an in-line view within the current document. For example, material that was at one point a part of the document appears in a strikethrough font, i.e. a horizontal line is drawn through the text. Though a strikethrough font is used, other font modifications may also serve as indicators as well. For example, a strikethrough font may be difficult to read, so deleted material or other material that is part of a previous version of the document may be represented by highlighted text, text in another color, an italicized or underlined font, larger or smaller sized font, an alternative font style or any combination of the characteristics, for example, deleted material may appear in a smaller red font, or a smaller italicized font.

In certain embodiments, deleted text may be of a different color in addition to the modified font, or instead of the modified font. For example, the font may be red or pink, to distinguish from text that represents the present document, which may be of another color, such as black. Additionally, the font may be either red or pink, and in strikethrough to further distinguish from unaltered font representing the present document. Depending on the indicators used by the system to distinguish the material, a key will be provided to educate the user accordingly as to what each indicator means. In certain embodiments, material that has been recently added material also appears as underlined to distinguish it from material that has not been recently added to the document.

In another embodiment, revisions may be viewed in line in a single view, identified by the date that a revision was added using certain indicators. For instance, material that was added or deleted on a particular date, may appear in blue font with strike through font indicating material that was deleted on that particular date, while material that was added or deleted on another particular date may appear in orange font color.

Additionally, blocks of material may appear within an outlined enclosure, and attached to a bubble containing information. The bubble may contain a variety of information about the material surrounded by outlined enclosure, such as whether the material was added, deleted or modified, when the information was added, deleted or modified, or general comments that may be useful in understanding the material.

Certain medical documents or data points include a variety of media, such as photos, video files, or audio files. In certain embodiments, changes may be identified within media files throughout the file history. For instance, an image, audio or video file that has been deleted from a document may appear as a hyperlink that may be selected by the user to view the contents of the once present file. Additionally, a media file that has been recently added may appear as it normally would, with a border of a particular color to indicate its recently added status.

One or more embodiments of the presently described invention provide, among other things, an improved method for presenting data in such a way that associations among data and/or events are graphically presented to a user. In doing so, users can view relationships and evolutions between data and/or events. In addition, users can avoid being confused by visual clutter caused by unrelated data or events. One particular application of the presently described technology is in the presentation of medical events and data included in a patient's EMR in such a way that associations among events and data related to one another and/or to a particular medical problem, hospital visit, encounter or medical test/examination, for example.

In certain embodiments, a timeline may be viewed and/or constructed using a system such as system 700 including at least one data storage 710 and at least one workstation 720. While three workstations 720 are illustrated in system 700, a larger or smaller number of workstations 720 can be used in accordance with embodiments of the presently described technology. In addition, while one data storage 710 is illustrated in system 700, system 700 can include more than one data storage 710. For example, each of a plurality of entities (such as remote data storage facilities, hospitals or clinics) can each include one or more data stores 710 in communication with one or more workstations 720.

As illustrated in system 700, one or more workstations 720 can be in communication with at least one other workstation 720 and/or at least one data storage 710. Workstations 720 can be located in a single physical location or in a plurality of locations. Workstations 720 can be connected to and communicate via one or more networks.

Workstations 720 can be directly attached to one or more data stores 710 and/or communicate with data storage 710 via one or more networks. Each workstation 720 can be implemented using a specialized or general-purpose computer executing a computer program for carrying out the processes described herein. Workstations 720 can be personal computers or host attached terminals, for example. If workstations 720 are personal computers, the processing described herein can be shared by one or more data stores 710 and a workstation 720 by providing an applet to workstation 720, for example.

Workstations 720 include an input device 722, an output device 724 and a storage medium 726. For example, workstations 720 can include a mouse, stylus, microphone and/or keyboard as an input device. Workstations 720 can include a computer monitor, liquid crystal display (“LCD”) screen, printer and/or speaker as an output device.

Storage medium 726 of workstations 720 is a computer-readable memory. For example, storage medium 726 can include a computer hard drive, a compact disc (“CD”) drive, a USB thumb drive, or any other type of memory capable of storing one or more computer software applications. Storage medium 726 can be included in workstations 720 or physically remote from workstations 720. For example, storage medium 726 can be accessible by workstations 720 through a wired or wireless network connection.

Storage medium 726 includes a set of instructions for a computer (described in more detail below). The set of instructions includes one or more routines capable of being run or performed by workstations 720. The set of instructions can be embodied in one or more software applications or in computer code.

Data storage 710 can be implemented using a variety of devices for storing electronic information such as a file transfer protocol (“FTP”) server, for example. Data storage 710 includes electronic data. For example, data storage 710 can store EMRs for a plurality of patients.

Communication between workstations 720, workstations 720 and data storage 710, and/or a plurality of data stores 710 can be via any one or more types of known networks including a local area network (“LAN”), a wide area network (“WAN”), an intranet, or a global network (for example, Internet). Any two of workstations 720 and data stores 710 can be coupled to one another through multiple networks (for example, intranet and Internet) so that not all components of system 700 are required to be coupled to one another through the same network.

Any workstations 720 and/or data stores 710 can be connected to a network or one another in a wired or wireless fashion. In an example embodiment, workstations 720 and data store 710 communicate via the Internet and each workstation 720 executes a user interface application to directly connect to data store 710. In another embodiment, workstation 720 can execute a web browser to contact data store 710. Alternatively, workstation 720 can be implemented using a device programmed primarily for accessing data store 710.

Data storage 710 can be implemented using a server operating in response to a computer program stored in a storage medium accessible by the server. Data storage 710 can operate as a network server (often referred to as a web server) to communicate with workstations 720. Data storage 710 can handle sending and receiving information to and from workstations 720 and can perform associated tasks. Data storage 710 can also include a firewall to prevent unauthorized access and enforce any limitations on authorized access. For instance, an administrator can have access to the entire system and have authority to modify portions of system 700 and a staff member can only have access to view a subset of the data stored at data store 710. In an example embodiment, the administrator has the ability to add new users, delete users and edit user privileges. The firewall can be implemented using conventional hardware and/or software.

Data store 710 can also operate as an application server. Data store 710 can execute one or more application programs to provide access to the data repository located on data store 710. Processing can be shared by data store 710 and workstations 720 by providing an application (for example, a java applet). Alternatively, data store 710 can include a stand-alone software application for performing a portion of the processing described herein. It is to be understood that separate servers may be used to implement the network server functions and the application server functions. Alternatively, the network server, firewall and the application server can be implemented by a single server executing computer programs to perform the requisite functions.

The storage device located at data storage 710 can be implemented using a variety of devices for storing electronic information such as an FTP server. It is understood that the storage device can be implemented using memory contained in data store 710 or it may be a separate physical device. The storage device can include a variety of information including a data warehouse containing data such as patient medical data, for example.

Data storage 710 can also operate as a database server and coordinate access to application data including data stored on the storage device. Data storage 710 can be physically stored as a single database with access restricted based on user characteristics or it can be physically stored in a variety of databases.

In an embodiment, data storage 710 is configured to store data that is recorded with or associated with a time and/or date stamp. For example, a data entry can be stored in data storage 710 along with a time and/or date at which the data was entered or recorded initially or at data storage 710. The time/date information can be recorded along with the data as, for example, metadata. Alternatively, the time/date information can be recorded in the data in manner similar to the remainder of the data. In another alternative, the time/date information can be stored in a relational database or table and associated with the data via the database or table.

In an embodiment, data storage 710 is configured to store medical data for a patient in an EMR. The medical data can include data such as numbers and text. The medical data can also include information describing medical events. For example, the medical data/events can include a name of a medical test performed on a patient. The medical data/events can also include the result(s) of a medical test performed on a patient. For example, the actual numerical result of a medical test can be stored as a result of a medical test. In another example, the result of a medical test can include a finding or analysis by a caregiver that entered as text.

In another example, the medical data/events can include the name and/or results of an imaging procedure. Such imaging procedures include, but are not limited to, CT scans, MRI scans, photographs, tomographic images, and computer models, for example.

The medical data/events can also include a description of a medical visit. For example, the medical data/event can list the date and/or time of a visit to a hospital, doctor's office or clinic, as well as details about what tests, procedures or examinations were performed during the visit. In addition, the data/event can include results of the tests, procedures and examinations as described above. The data/event can include the names of all caregivers that came into contact or provided medical care to the patient during the visit. The data/event can also include information on the length of the visit, as well as any symptoms complained of by a patient and/or noted by a caregiver or other staff.

In another example, the medical data/events can include a description of a medical problem that a patient is experiencing. For example, an injury can be recorded as a medical problem, as well as any illnesses (chronic or otherwise) a patient is experiencing.

The medical data/events can also include details of a caregiver encounter. For example, the data/event can include information such as the date/time of an encounter with a doctor, nurse or other caregiver (such as a radiologist, for example). The data/event can include additional information such as what medical tests, examinations or procedures were performed on a patient by a specific caregiver. For example, if nurse “X” takes a blood sample from a patient, records the weight of a patient and tests the patient's blood pressure, then all of these tests and procedures, as well as the results, can be recorded as medical data/events associated with nurse X.

In another example, medical data/events can include a description and/or results of a medical procedure. For example, the name and outcome of a surgery or outpatient procedure can be recorded as a medical procedure.

Medical data/events can also include a description of any symptoms experienced by a patient. This information can be recorded as text or by a codification scheme. For example, medical data/events can include descriptions such as a headache, chest pains or dizziness.

The medical data/events stored in a patient's EMR can also include any biological analyses performed on the patient. For example, the data/events can include the numerical results of blood, enzyme or other fluid tests. In another example, the data/events can include a text description of the results of a biological analysis.

In another example, the medical data/events can include a finding by a caregiver. A finding can include any numeric and/or text-based description of a discovery or analysis made by the caregiver. For example, a radiologist can analyze a series of x-ray images of a patient and find a growth or tumor in the patient. The radiologist can then record his or her finding in a patient's EMR.

The medical data/events can also include one or more medications a patient is or has taken. The data can include the date, time, dosage and/or name of medication, for example.

The medical data/events can also include one or more acquisitions. An acquisition can include any actual data acquired and/or the date at which the data is acquired. For example, an acquisition can include the results and/or date/time at which results from a laboratory test were acquired.

One or more types of similar data/events is included in a category of data/events. In continuing with the above example, a category of medical data/events can include all “tests” (including all test results or “test results” being a separate category), “imaging procedures” (including all images obtained therefrom or “images” being a separate category), “visit,” “problems,” “encounters,” “medical procedures” (including all results or “medical procedure results” being a separate category), “symptoms,” “biological analyses” (including all results of such analyses or “biological analysis result(s)” being a separate category), “findings,” “medications,” and/or “results.”

While the above provides several examples of the types of medical data/events that can be used in accordance with embodiments of the presently described technology, it is to be understood that the presently described technology is not limited to the above data/events. In addition, while some types of information stored as medical data/events described above is repeated, it is to be understood that various medical data/events can be stored multiple times. For example, if a patient complains of a symptom to a caregiver during a particular office visit, the symptom can be recorded by itself and/or with additional information, such as the name of the caregiver and any procedures performed on the patient.

In an embodiment, the medical data/events include the actual information desired to be stored. Alternatively, the medical data/events can include a code representative of the actual information desired to be stored. For example, the codes provided by the International Statistical Classification of Diseases and Related Health Problems (“ICD”) can be stored in place of the actual information related to the medical data/event.

In operation, a user employs a workstation 720 to display, on an output device 724, a timeline of data and/or events stored at data storage 710 in a chronological order with one or more associations among a plurality of the data and/or events visually represented to the user. As described above, workstation 720 includes computer-readable storage medium 726 that itself comprises a set of instructions for workstation 720. The set of instructions can be embodied in one or more computer software applications or computer code. This set of instructions is used by workstation 720 to access and display data and/or events and one or more associations among a plurality of the data/events. Thus, at least one technical effect of the set of instructions is to modify the display and presentation of at least a subset of data so as to enable a user to quickly and easily note associations among the data.

The set of instructions includes one or more software routines. In an embodiment of the presently described technology, the set of instructions includes a display routine, a data routine and a filter routine. These routines operate to determine and display associations among related data/events on display device 722.

Data/events can be displayed by representing each of the data/events by a symbol on one or more timelines, for example. Timelines may include medical events belonging to particular categories, for example. These timelines are also referred to as timeline metaphors. Timeline metaphors can be used in EMR software applications to provide users with the ability to navigate through a patient's medical history chronologically. In many cases, every patient encounter with a caregiver or hospital is listed as a separate item on a timeline. For example, timelines may present medical events and/or data by illustrating the date and/or time at which the medical event or data occurred, was collected or was entered.

In an embodiment, each data/event is represented by a graphical symbol. The exact symbol used can differ in accordance with the presently described technology. In an embodiment, the same symbol is used for all similar data/events. For example, the same symbol can be used for all medical data/events in a category of data/events.

A timeline can include data/events from a given category presented in chronological order. The number of timelines therefore can change based on the number of categories of data/events to be presented.

In certain embodiments, a user can select which categories and/or timelines are displayed. For example, using input device 722, the user can select one or more categories to be presented on output device 724. The display routine and the data routine can then obtain the data/events in the selected category(ies) and display the data/events as shown in a presentation on output device 724. In addition, the user can select the date and/or time range over which the data/events are to be presented in timelines.

In an embodiment, a user can scroll an icon over a symbol and the display routine will cause additional information related to the symbol to be presented to the user. For example, a user can employ input device 722 to move an arrow displayed on output device 724 over a symbol. Once the arrow is over the symbol (or once the user “clicks” or otherwise selects the symbol using input device 722), additional information about the data/event represented by symbol can be presented by the display routine on output device 726. For example, the display routine can cause popup window to appear and present the actual data/event (or a portion thereof) represented by the symbol.

In certain embodiments, a filter may be created by a user. The filter is used to determine which symbols represent events/data that are associated with one another, if any.

The filter comprises one or more rules. These rules are compared to all or a subset of the events/data. If any of the events/data satisfy or match each of the rules, the events/data are considered to be associated with one another. Such events/data are referred to as associated events/data. If any of the events/data do not satisfy or match all of the rules, the events/data are considered to not be associated with one another.

In an embodiment, a user creates a filter by employing input device 722 to select one or more predefined rules that are displayed on output device 726. The selected rules are then included in the filter.

In another embodiment, a user employs input device 722 to select a predefined filter. The predefined filter is a filter previously created by a user and stored on a computer-readable memory such as data store 710 or storage medium 726, for example.

The rules can include any criteria useful to determine whether a given data/event or subset of data/events fall within, or satisfy, the rule. For example, a rule can be stated as all data/events collected and/or entered during a particular patient's visit to a hospital. All data/events that were collected and/or entered during that visit would therefore fall within the scope of this rule and therefore be considered associated data/events.

In another example, a rule can define a set of data/events that are normally related with one another. For example, a typical doctor's office visit for a physical involves several routine tests such as tests on blood pressure, weight, reflexes, and/or blood. A rule can set one or more criteria that would include all medical data/events in a patient's EMR that includes information about and the results for blood pressure tests, weight measurements, reflex test results and blood test results. This rule can then be applied to a patient's EMR to determine which medical data/events includes data from blood pressure tests, weight measurements, reflex test results and blood test results. This data is then considered to be associated data.

In another example, a rule can define one or more criteria that associate all data/events related to a single patient encounter or a selected time and/or date range. Such a criteria can state that all data/events that were collected and/or entered during that encounter or during the time and/or date range selected by the user.

Another example of a rule is one in which all data/events from a particular medical test or examination are associated with one another. For example, a rule can state that all data/events describing a test and the results of that test are associated. Such a rule would associate a description of a blood test and all chemical and biological analyses from that blood test as associated data/events.

In another example, a rule can define one or more criteria that associate all data/events collected and/or entered by one caregiver or group of caregivers and excludes all data/events collected and/or entered by all other caregivers. For example, such a rule can associate all test results collected by a particular nurse and exclude all test results entered by other nurses.

In another example, a rule can define one or more criteria that associate all data/events with a predefined association with a selected medical problem and/or medical procedure. For example, the data/events stored at data store 710 can have a predefined association with one another based on an underlying problem or test. The medical problem of diabetes could have predefined association with tests such as eye examinations, foot examinations, blood sugar test results, hemoglobin Alc results and urine tests, for example. A medical procedure such as a surgery can have a predefined association with one or more caregivers' names involved in the surgery and in the recovery from surgery, test results related to the surgery and/or related symptoms, for example. All data/events with such predefined associations can be considered associated data/events according to such a rule.

The predefined associations can be stored or recorded in a variety of manners. For example, metadata included in the actual data/events stored at data store 710 can include the predefined associations. In another example, the actual data/events can have the predefined associations recorded in the data itself. A relational database or table stored at data store 710 can also include the predefined associations, for example.

Once the filter is selected or created by a user, the filter is used to determine if any associations exist among the data/events displayed on output device 726. A filter routine can determine if any associations exist among the displayed data/events by applying the filter to the data/events. The filter routine can apply the filter by comparing the criteria defined by the rule(s) of the filter to the data/events displayed on output device 726. For example, the filter routine can apply the filter by searching through all or a subset of data/events stored at data store 710 and comparing the criteria of the filter rule(s) to the data/events.

In an embodiment, the filter routine determines that data/events are associated data/events only if each and every one of the criteria defined by the filter is matched or satisfied. For example, if one or more criteria are not met by a particular data/event, then that data/entry is not considered to be associated with the data/events that meet each of the criteria.

In another embodiment, the filter routine determines that data/events are associated data/events if a number of the criteria defined by the filter that is greater than a predefined threshold is matched or satisfied. For example, if a predefined threshold requires that 75% of the filter's criteria be met in order for the data/events to be associated data/events, any data/events that does not meet at least 75% of the criteria is not considered associated data/events. Conversely, all data/events that do meet at least 75% of the criteria are associated data/events, for example.

Once the associated data/events are determined, a visual representation of the associated data/events may be created. In an embodiment, a display routine causes a visual representation of the association among the associated data/events to appear on output device 726.

In certain embodiments, a rendering engine may “chart” or map aggregated data into a single timeline interface, such as the interface described above. As new data is collected, the rendering engine can “redraw” the timeline and update the interface.

An association can be represented or displayed using any graphical object. For example, one or more lines can be displayed among symbols of associated data/events. A line representing an association can cross one or more timelines as one or more symbols in each of a plurality of categories can be associated with one another. In another example, one or more geometric shapes can surround one or more symbols of associated data/events. Such geometric shapes can include a circle, oval, square, rectangle or triangle, for example. In addition, the geometric shape can surround one or more of symbols of associated data/events. In another example, the association(s) among symbols of associated data/events can be illustrated by changing the brightness, contrast and/or color of the symbols representing a group of associated events/data. An association can also be represented by changing the symbol used to represent associated events/data, for example.

One or more embodiments of the presently described invention provide several advantages. For example, embodiments of the presently described technology allow users to more clearly see relationships of data/events on a timeline due to graphical associations such as color coding and schematics that more clearly describe the relationships. In addition, embodiments of the presently described technology allow extraneous information to a particular data/event (such as a patient event, for example) to be disassociated with a particular grouping of associated data/events. In addition, using embodiments of the presently described technology, relevant information can be accessed without the uncertainty of accessing unrelated data/events that occur in close proximity to related data/events.

Certain embodiments provide methods and systems providing clinical display and search capabilities for all of a patient's electronic medical record data from a variety of disparate information systems. Certain embodiments provide a full clinical display and search functionality for a complete set of patient electronic medical record data from a variety of disparate information systems. For example, a worklist or browser queries all available enterprise hospital information systems and aggregates the data into a single, interactive window that displays all results and data points from a particular patient search. The worklist/browser can display information from Radiology, Cardiology, Pharmacy, Medication, Lab information systems, etc.

In certain embodiments, column headings for one or more searches can be user configurable to display metadata relevant to specific users. Column headings can filter the patient information via dynamic keystrokes and/or specific drop down menus related to each column heading, for example. For example, certain column headings allow users to filter based on specific type(s) of EMR patient data to display. Certain column headings allow users to filter data points based on date(s) and/or date range(s), for example. Certain embodiments allow filtering of data based on visit (e.g., last visit, last five visits, last “N” visits, etc.), for example. An ability to search and filter a patient's full electronic medical record helps enable physicians to fully visualize a full context to a patient's health or pathology, for example.

In certain embodiments, as a user navigates away from one patient, an interface system can automatically save the last state of the interface. Saved user interface context may include open windows, completed fields, positions in multi-step workflows, etc., for a patient chart or record. This “patient context” is stored and represented to the user as an icon within the interface and/or other context manager, for example. In order to get back to the patient context of any saved state, the user clicks on or otherwise selects the icon representing the last patient context within the software. By clicking a single button, the user is able to toggle back and forth between multiple patient contexts in a single session, thus helping to reduce an amount of effort and navigation to complete clinical tasks.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device, such as, for example, a PACS workstation or one or more dedicated processors.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any medical navigation system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A user interface system displaying an electronic patient record, said system comprising:
a timeline representation of a patient record, said timeline including a plurality of data points related to a patient over time, said plurality of data points providing patient data aggregated from a plurality of information sources, said timeline providing access to and review of said plurality of data points within a single view; and
one or more controls allowing navigation and manipulation of one or more of said plurality of data points in said timeline.

2. The system of claim 1, further comprising a viewing surface for displaying said timeline representation and facilitating said one or more controls for navigation and manipulation of one or more of said plurality of data points in said timeline.

3. The system of claim 2, wherein said viewing surface comprises a touch screen.

4. The system of claim 3, wherein said touch screen comprises a multiple user touch screen allowing one or more users to at least one of view and modify information in the timeline at least substantially simultaneously.

5. The system of claim 2, wherein said viewing surface comprises a viewing table.

6. The system of claim 1, wherein said plurality of data points comprise editable data points and wherein said data points allow viewing of finer granularity information via the single view.

7. The system of claim 1, wherein said one or more controls facilitate addition of information to said timeline by at least one of inputting at least one of textual data and multimedia data, accepting voice commands and synchronizing with at least one healthcare information system.

8. The system of claim 1, wherein said timeline provides viewing of additional information, editing of data points and annotation of data relationships at increasing levels of magnification with said timeline.

9. The system of claim 1, wherein said timeline provides an indication of certain results related to one or more of said plurality of data points within the view.

10. A comprehensive patient record comprising electronic patient data for a patient lifetime, said electronic patient data arranged in chronological order and viewable in a single context at varying degrees of granularity within said single context, said electronic patient data aggregated from a plurality of data sources for viewing and modification via said single context.

11. The record of claim 10, wherein said record is stored on a portable medium.

12. A method for providing comprehensive clinical documentation for a patient lifetime via a single, unified interface, said method comprising:
providing a comprehensive patient record, said record comprising a plurality of data points related to a patient over time, said plurality of data points providing patient data aggregated from a plurality of information sources, said record providing access to and review of said plurality of data points within a single patient context; and
manipulating said record based on input from an interface to access finer granularity information from said record.

13. The method of claim 12, further comprising editing said patient record based on input from said interface.

14. The method of claim 13, further comprising saving said patient record after said editing step.

15. The method of claim 12, further comprising aggregating data for a patient from a plurality of information sources.

16. The method of claim 15, further comprising saving said aggregated patient data in a single patient context to form said comprehensive patient record.

17. The method of claim 12, further comprising annotating said record to relate one or more data points in said record.

18. The method of claim 12, wherein said manipulating step further comprises manipulating said record using one or more controls to facilitate addition of information to said record by at least one of inputting at least one of textual data and multimedia data, accepting voice commands and synchronizing with at least one healthcare information system.

19. The method of claim 12, wherein said plurality of data points comprise editable data points and wherein said data points allow viewing of finer granularity information via the single patient context.

20. The method of claim 12, wherein said manipulating step further comprises allowing a plurality of users to at least one of view and modify information in the timeline at least substantially simultaneously.

21. The method of claim 12, further comprising rendering said plurality of data points for said patient record in a single timeline interface, said rendering updateable as one or more of said plurality of data points changes.

22. A computer readable medium having a set of instructions for execution on a computer, said set of instructions comprising:
a user interface routine displaying an electronic patient record, said electronic patient record including a plurality of data points related to a patient over time, said plurality of data points providing patient data aggregated from a plurality of information sources, said interface routine providing access to and review of said plurality of data points within a single view; and
a control routine facilitating navigation and manipulation of said electronic patient record to at least one of view and modify one or more of said plurality of data points in said record.
